(19) United States
(12) Patent Application Publication
(10) Pub. No.: US 2009/0109491 A1
(43) Pub. Date: Apr. 30, 2009

(54) RAW-QUALITY PROCESSING OF NON-RAW IMAGES

(75) Inventor: Steven James White, Seattle, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 11/929,752

(22) Filed: Oct. 30, 2007

(51) Int. Cl. G06K 15/00

(52) U.S. Cl. 358/3.23

(57) ABSTRACT

Technologies, methods, and systems for generating and maintaining profile information with processed image data, and for enabling scene-referred high-fidelity adjustments to non-raw, processed image data.

### BACKGROUND

Raw digital image processing supports high-fidelity adjustments to image color and exposure and the like. Raw processing is typically simple and well understood. Alternatively, processed images flattened and encoded in output-referred device-space mappings do not lend themselves to high-fidelity color and exposure adjustments since nonlinear processing stages (e.g. some types of saturation, contrast, film appearance, gamma mapping) make it difficult or impossible for a processor to know what adjustments or corrections are needed for each pixel color. Adjustments to such processed images typically result in noticeably worse color quality and exposure adjustments and adversely affects the quality of virtually all other adjustments as well. In addition to limited pixel precision and compression artifacts, low-fidelity color correction is yet another, and arguably the most significant, shortcoming of adjusting processed vs raw images.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present examples provide methods, systems and technologies for generating and maintaining profile information with processed image data (also known as output-ready or output referred), and for enabling scene-referred high-fidelity adjustments to non-raw, processed image data.

Many of the attendant features will be more readily appreciated as the same become better understood by reference to the following detailed description considered in connection with the accompanying drawings.

### DESCRIPTION OF THE DRAWINGS

The present description will be better understood from the following detailed description considered in connection with the accompanying drawings, wherein:

FIG. 1 is a block diagram showing an example generic image processing pipeline system.

FIG. 2 is a block diagram showing an example conventional method of processing raw sensor data and the like.

FIG. 3 is a block diagram showing another example method of processing raw sensor data and the like.

FIG. 4 is a block diagram showing yet another example method of processing raw sensor data and the like using a color lookup table.

FIG. 5 is a block diagram showing an example method of processing raw sensor data and the like using a color lookup table and a color look-up table Color Management Module to provide ready-to-render image data.

FIG. 6 is a block diagram showing an example method for processing image data such as that produced by method 500 of FIG. 5 and the corresponding CLUT to make further scene-referred adjustments to the image data.

FIG. 7 is a block diagram showing an example method for generating a revised CLUT.

FIG. 8 is a block diagram showing a method for processing image data and a corresponding CLUT to make further scene-referred adjustments to the image data resulting in revised image data and for generating a corresponding revised CLUT.

FIG. 9 is a block diagram showing an example computing environment in which the technologies described herein may be implemented.

Like reference numerals are used to designate like elements in the accompanying drawings.

### DETAILED DESCRIPTION

The detailed description provided below in connection with the accompanying drawings is intended as a description of the present examples and is not intended to represent the only forms in which the present examples may be constructed or utilized. The description sets forth at least some of the functions of the examples and/or the sequence of steps for constructing and operating examples. However, the same or equivalent functions and sequences may be accomplished by different examples.

Although the present examples are described and illustrated herein as being implemented in a computing environment, the environment described is provided as an example and not a limitation. As those skilled in the art will appreciate, the present examples are suitable for application in a variety of different types of computing environments.

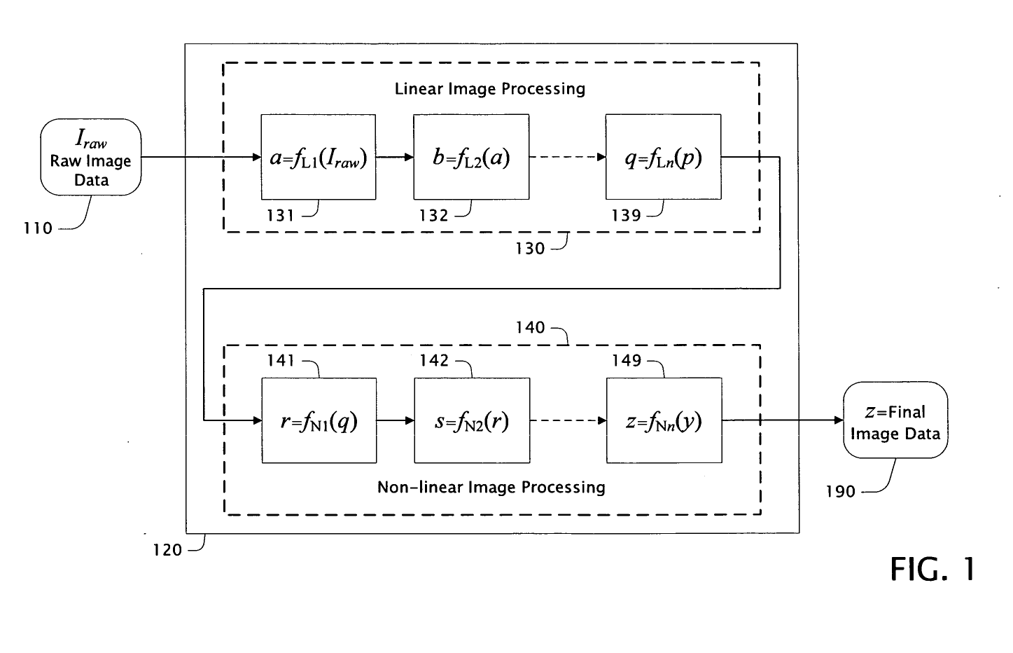

FIG. 1 is a block diagram showing an example generic image processing pipeline system 120. Pipeline 120 typically takes as its input raw image data I_{raw} 110. In one example, raw image data 110 may be in the form of a raw image file or the like. A raw image file (or raw image data) typically contains minimally processed data from the image sensor of a digital camera or image scanner or the like. Raw data/files are so named because they tend to be unprocessed or little processed and are ready to be used with image processing software or tools or the like. Raw image data/files may also be referred to as scene-referred data/files given a simple linear relationship between the two. The term “image device” as used herein typically includes any device useful in producing digital image data, such as a digital camera, image scanner, or the like. The terms “digital image data”, “image data”, “digital image file”, and “image file” as used herein are generally used synonymously.

Pipeline 120 generally includes two broad categories of image or pixel color processing: linear 130 and nonlinear 140. Linear image processing 130 typically includes any number of stages of processing in which the pixels of the image data are all changed or adjusted using linear transforms or the like. Examples of such stages are represented by blocks 131, 132, and 139. In one example, some linear processing may include processing performed by an image device, such as various device-specific pre-processing steps, exposure adjustment, and the like. The result of such image device linear processing may be an image file in a working format, such as red-green-blue (“RGB”) and is sometimes referred to as being a “Rare” format.

Other stages of processing may be performed by the image device, image processing tools, and/or the like. Such tools may or may not be distinct from the image device. In one example, other stages of linear processing include white balancing, exposure adjustments, and the like. Note that the output of each stage of processing generally constitutes the input of the next stage, the raw data 110 being the initial input to stage 131.

Stages of processing—both linear and nonlinear—may include transformations, interpolations, and the like as represented, for example, by the notation a=f_{L1}(I_{raw}) in block 131 (where f_{L1} represents the first linear processing stage, I_{raw} the input data 110 to f_{L1}, and a the output of f_{L1}) and similar notation in blocks 132, 133, 141, 142, and 149. Such processing typically begins with initial linear processing and then proceeds to non-linear processing, but in practice the stages of linear and nonlinear processing may be applied in arbitrary order after the initial linear processing stages.

Nonlinear image processing 140 typically includes any number of stages of processing in which the pixels of the image data may be changed or adjusted using non-linear transforms. Examples of such stages are represented by blocks 141, 142, and 149. In one example, some stages of nonlinear processing include nonlinear adjustments such as contrast, saturation adjustments, and the like. Finally, the processed image data is provided as final image data z 190. In one example, final image data 190 is provided in the form of a file. Final image data 190 may later be rendered for use with some form of output device, such as a printer, display, or the like.

In general, once nonlinear processing has been performed on the image data, it may not be possible to further adjust the final data with the same level of quality as during initial linear stages. This is because further processing typically requires information regarding the various stages of processing from the raw image to the final image. Without this information it may not be possible to properly adjust each pixel of the final image to achieve the same effect as with the adjustments of earlier linear stages. Additional data may be maintained with image data in order to provide the information needed for further high-fidelity processing. In one example, such additional data is maintained in the form of one or more profiles stored with an image file. One example of such profiles are International Color Consortium (“ICC”) profiles.

Profiles that provide information describing the mapping of image data between the original captured scene colors and the colors encoded in the final format are typically referred to as scene-referred profiles. Scene-referred profiles provide information sufficient to map the current image data back to raw image data, or to a close approximation of the raw image data. The terms “current image data” and “current format” as used herein typically refers to the format of image data to which a profile is associated. One example of current image data and an associated profile is an image file including a corresponding profile.

Profiles that provide information describing changes for transforming current image data into a format suitable for a particular output device, such as a printer, display, or the like, is typically referred to as an output-referred profile. Output-referred profiles generally do not include information suitable for mapping current image data back to raw, or scene, image data, but instead facilitates mapping of current image data to a specific output device. Other profile types may also be defined.

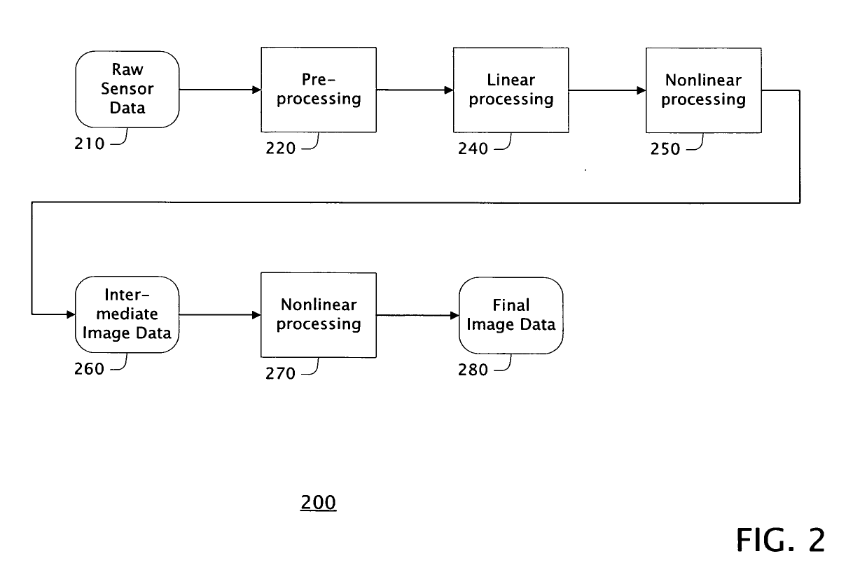

FIG. 2 is a block diagram showing an example conventional method 200 of processing raw sensor data 210 and the like. Method 200 includes pre-processing 220 of the raw sensor data 210 on which is performed first various linear 240 and then nonlinear 250 processing steps resulting in intermediate image data 260. Note that nonlinear 250 processing steps may also include other linear processing steps arbitrarily mixed in. Method 200 then includes further nonlinear 270 processing steps (as well as possible arbitrary linear processing steps) on the intermediate image data 260 resulting in final image data 280 ready for rending to an output device or the like.

Block 210 typically represents the data provided by a sensor of an image device, such as a digital camera or scanner or the like. Once raw sensor data is available, method 200 typically continues at block 220.

Block 220 typically indicates pre-processing of the raw sensor data 210. In one example, the pre-processing is performed by an image device containing the sensor. Such pre-processing tends to be linear in nature. Once the pre-processing is complete, method 200 typically continues at block 240.

Block 240 typically indicates various stages of linear processing of raw image data 230. Such linear processing may includes examples such as white balance, exposure adjustment, and the like as provided herein above in connection with FIG. 1. Once the linear processing stages are complete, method 200 typically continues at block 250.

Block 250 typically indicates various stages of nonlinear processing of the raw image data as processed in the stages represented by block 240. Such nonlinear processing may include examples as provided herein above in connection with FIG. 1, and the like. Once the nonlinear processing stages are complete, method 200 typically continues at block 260.

Block 260 typically represents intermediate image data resulting from the previous stages of processing (e.g., blocks 220, 240, and 250). In one example, intermediate image data 260 is provided in the form of a flattened image file that includes an output-referred profile. The term “flattened image file” as used herein typically refers to a file that does not include information about color mappings to the source data or how it was processed. Once the intermediate image data is available, method 200 often continues with additional processing steps at block 270.

Block 270 typically indicates various stages of nonlinear processing of the intermediate image data 260. In one example, the intermediate image data is provided in the form of a flattened image file that includes an output-referred profile. Because the image data is output-referred, adjustments for color and exposure and the like cannot typically be performed so as to achieve the same high-fidelity results as can be achieved in stages 220 and 240. Once the nonlinear processing stages are complete, method 200 typically continues at block 280.

Block 280 typically represents final image data ready for rendering to an output device. At this point method 200 is typically complete. While method 200 typically produces ready-to-render images, it does so by too quickly converting to an output-referred format 260 thus making post-intermediate high-fidelity changes difficult at best.

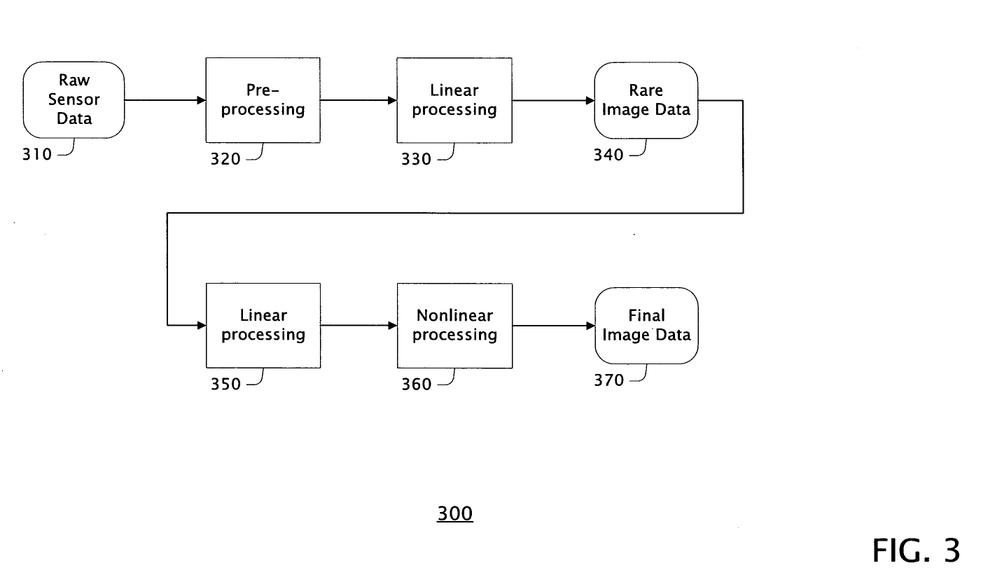

FIG. 3 is a block diagram showing another example method 300 of processing raw sensor data 310 and the like. Method 300 preserves the high-fidelity adjustment capabilities of scene-referred processing by maintaining image data in a “Rare” format—an intermediate format between Raw 310 and Final 370.

Block 310 typically represents the data provided by a sensor of an image device, such as a digital camera or scanner or the like. Once raw sensor data is available, method 300 typically continues at block 320.

Block 320 typically indicates pre-processing of the raw sensor data 310. In one example, the pre-processing is performed by an image device containing the sensor. Such pre-processing tends to be linear in nature. Once the pre-processing is complete, method 300 typically continues at block 330.

Block 330 typically indicates various stages of linear processing of raw image data 310 as adjusted by pre-processing block 320. Such linear processing may include examples as provided herein above in connection with FIG. 1, and the like. Once the linear processing stages are complete, method 300 typically continues at block 340.

Block 340 typically represents rare image data that is in a scene-referred format such as extended standard RGB (“scRGB”) and the like. In one example, the rare image data is provided in the form of a rare image file that includes a scene-referred profile. Because the image data is scene-referred, adjustments for color and exposure and the like can be performed via linear processing to achieve high-fidelity results. Once the rare image data is available, method 300 typically continues at block 350.

Block 350 typically indicates various stages of linear processing of rare image data 340. Such linear processing may include examples as provided herein above in connection with FIG. 1, and the like. Once the linear processing stages are complete, method 300 typically continues at block 360.

Block 360 typically indicates various stages of nonlinear processing of the raw image data as processed in the stages represented by block 350. Such nonlinear processing may include examples as provided herein above in connection with FIG. 1, and the like. Once the nonlinear processing stages are complete, method 300 typically continues at block 370.

Block 370 typically represents final image data ready for rendering to an output device. At this point method 300 is typically complete. Method 300 typically preserves the high-fidelity adjustment capabilities of scene-referred processing by maintaining rare image data. Unfortunately, the raw image data may not include nonlinear processing results required for simple output-referred rendering and at the same time maintain its scene-referred format. This may be included by embedding an ICC profile with image data 340 that describes these nonlinear steps.

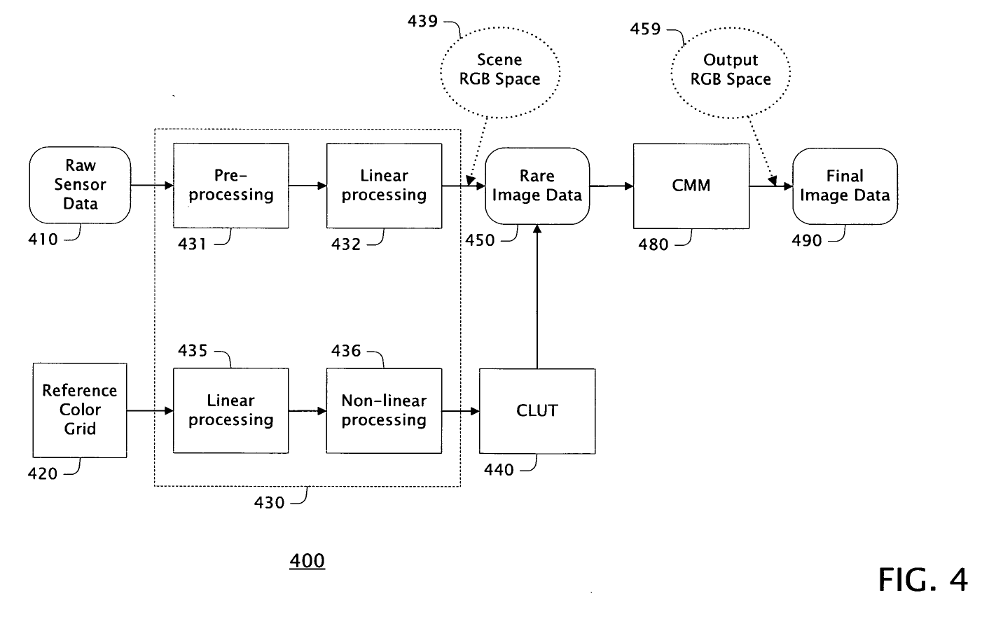

FIG. 4 is a block diagram showing yet another example method 400 of processing raw sensor data 410 and the like using a color lookup table 440. Method 400 provides for the output-referred rendering of method 200 while preserving the high-fidelity adjustment capabilities of scene-referred processing of method 300. In general, the steps of method 400 may be performed on a digital camera and/or on any other computing device, such as a personal computer (“PC”) or the like.

Block 410 typically represents the raw image data provided by a sensor of an image device, such as a digital camera or scanner or the like. Raw image data 410 or the like is typically provided as input to pipeline 430. Once raw sensor data is available, method 400 typically continues at block 420.

Block 420 typically represents a reference color grid (“RCG”). RCG 420 is typically a collection of values representing various colors. RCG 420 or the like is typically provided as input to pipeline 430. In one example, RCG 420 is a collection of RGB values for select colors such as black, white, red, green, and blue. Other colors may also be represented in the grid. Once the RCG is available, method 400 typically continues at block 430.

Block 430 typically represents an example image processing pipeline. In this example, pipeline 430 processes both the raw sensor data 410 or the like and the RCG 420. Processing typically includes pre-processing and linear processing of raw sensor data 410 as well as linear and nonlinear processing of RCG 420. The outputs of pipeline 430 typically include rare image data 450 as well as a color look-up table (“CLUT”) 440. Method 400 typically continues at block 431.

Block 431 typically indicates pre-processing of the raw sensor data 410. In one example, the pre-processing is performed by module 431 of pipeline 430. In an alternative example, the pre-processing is performed by an image device containing the sensor. Such pre-processing tends to be linear in nature. Once the pre-processing is complete, method 400 typically continues at block 432.

Block 432 typically indicates various stages of linear processing of raw image data 410 as adjusted by pre-processing stage 431. Such linear processing typically includes mapping from a camera color space to a scene-referred color space. In one example, the result of the linear processing stages is image data in a scene-referred RGB space or the like (as indicated by bubble 439). Once the linear processing stages are complete, method 400 typically continues at block 450.

Block 450 typically represents rare image data that is in a scene-referred format such as scRGB or the like. Rare image data 450 is typically provided as output from pipeline 430. In one example, the rare image data is provided in the form of a rare image file that includes a scene-referred and output-referred profile. Because the image data is scene-referred, adjustments for color and exposure and the like can be performed via linear processing to achieve high-fidelity results. Once the rare image data is available, method 400 typically continues at block 435.

Block 435 typically indicates various stages of linear processing of RCG 420. Such linear processing stages typically include white balance, exposure adjustments, and the like. Once the linear processing stages are complete, method 400 typically continues at block 436.

Block 436 typically indicates various stages of nonlinear processing of RCG 420 as adjusted by linear processing block 435. Such nonlinear processing stages are the same as would normally be performed on image data and may include examples as provided herein above in connection with FIG. 1, and the like. Once the nonlinear processing stages are complete, method 400 typically continues at block 440.

Block 440 typically represents a CLUT resulting from the linear 435 and nonlinear 426 processing of RCG 420. CLUT 440 is typically provided as output from pipeline 430. Look-up table 440 typically includes information mapping all reference color values to processed color values and the inverse, that is, information to map all processed color values back to reference color values. Further, the information included can be interpolated for colors not represented in RCG 420 based on the colors that are represented. CLUT 440 is typically added as an output-referred ICC profile to rare image data 450. Once CLUT 440 is added to the profile of rare image data 450, method 400 typically continues at block 480.

Block 480 typically represents a Color Management Module (“CMM”) suitable for mapping image data in one color space to another color space. In one example, CMM 480 processes the rare image data 450 in a scene-referred RGB color space (as indicated by bubble 439) by using ICC profile CLUT 440 into final image data 490 in a output-referred color space (as indicated by bubble 459), such as for a printer or display or the like, or to a file stream. Once the CMM completes conversion of rare image data 450, method 400 typically continues at block 490.

Block 490 typically represents final image data ready for output on an output device. At this point method 400 is typically complete. Method 400 typically produces ready-to-render images, and typically preserves the high-fidelity adjustment capabilities of scene-referred processing by maintaining rare image data. Unfortunately, CMM 480 may be required to perform sophisticated conversions based in part on CLUT 440 to produce ready-to-render image data.

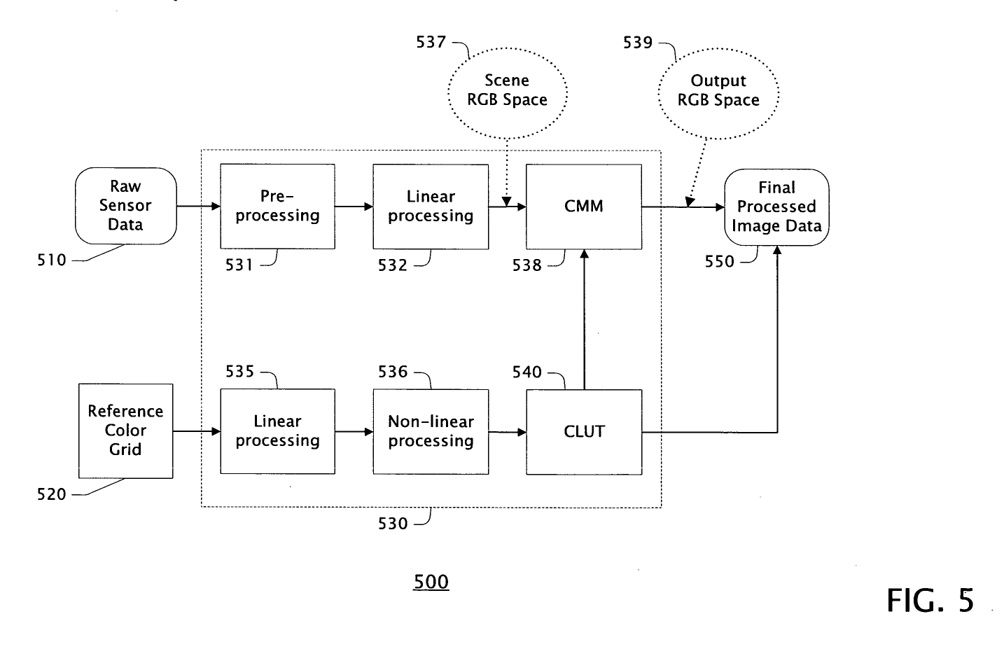

FIG. 5 is a block diagram showing an example method 500 of processing raw sensor data 510 and the like using a color lookup table (“CLUT”) 540 and a color look-up table Color Management Module (“CLUT CMM”) 538 to provide ready-to-render image data 550. In general, the steps of method 500 may be performed on a digital camera and/or on any other computing device, such as a PC or the like.

Block 510 typically represents the raw image data provided by a sensor of an image device, such as a digital camera or scanner or the like. Raw image data 510 or the like is typically provided as input to pipeline 530. Once raw sensor data is available, method 500 typically continues at block 520.

Block 520 typically represents a reference color grid (“RCG”). RCG 520 is typically a collection of values representing various colors. RCG 520 or the like is typically provided as input to pipeline 430. In one example, RCG 520 is a collection of RGB values for select colors such as black, white, red, green, and blue. Other colors may also be represented in the grid. Once the RCG is available, method 500 typically continues at block 530.

Block 530 typically represents an example image processing pipeline. In this example, pipeline 530 processes both the raw sensor data 510 or the like and the RCG 520. Processing typically includes pre-processing and linear processing of raw sensor data 510 as well as linear and nonlinear processing of RCG 520. The outputs of pipeline 530 typically include processed image data 550 in a ready-to-render format. Method 500 typically continues at block 531.

Block 531 typically indicates pre-processing of the raw sensor data 510. In one example, the pre-processing is performed by module 531 of pipeline 530. In an alternative example, the pre-processing is performed by an image device containing the sensor. Such pre-processing tends to be linear in nature. Once the pre-processing is complete, method 500 typically continues at block 532.

Block 532 typically indicates various stages of linear processing of raw image data 510 as adjusted by pre-processing stage 531. Such linear processing typically includes mapping from a camera color space to a scene-referred color space. In one example, the result of the linear processing stages is image data in a scene-referred RGB space or the like (as indicated by bubble 537). Once the linear processing stages are complete, method 500 typically continues at block 535.

Block 535 typically indicates various stages of linear processing of RCG 520. Such linear processing stages typically include white balance, exposure adjustments, and the like. Once the linear processing stages are complete, method 500 typically continues at block 536.

Block 536 typically indicates various stages of nonlinear processing of RCG 520 as adjusted by linear processing block 535. Such nonlinear processing stages are the same as would normally be performed on image data and may include examples as provided herein above in connection with FIG. 1, and the like. Once the nonlinear processing stages are complete, method 500 typically continues at block 540.

Block 540 typically represents a CLUT resulting from the linear 535 and nonlinear 526 processing of RCG 520. Look-up table 540 typically includes information mapping all reference color values to processed color values and can be utilized to produce the inverse, that is, information to map all processed color values back to reference color values. Further, the information included can be interpolated for colors not represented in RCG 520 based on the colors that are represented. CLUT 540 is typically added as an output-referred profile to processed image data 550. Once CLUT 540 is formed, method 500 typically continues at block 538.

Block 538 typically represents a Color Management Module capable of processing image data in a scene-referred RGB space or the like, along with CLUT 540, to produce processed image data 550. Once CMM processing is complete, method 500 typically continues at block 550.

Block 550 typically represents final processed image data that is ready to render to an output device. Processed image data 550 typically includes a scene-referred profile including CLUT 540 or the like as well as a simple output-referred profile to assist in rendering. Final processed image data 550 is typically provided as output from pipeline 530.

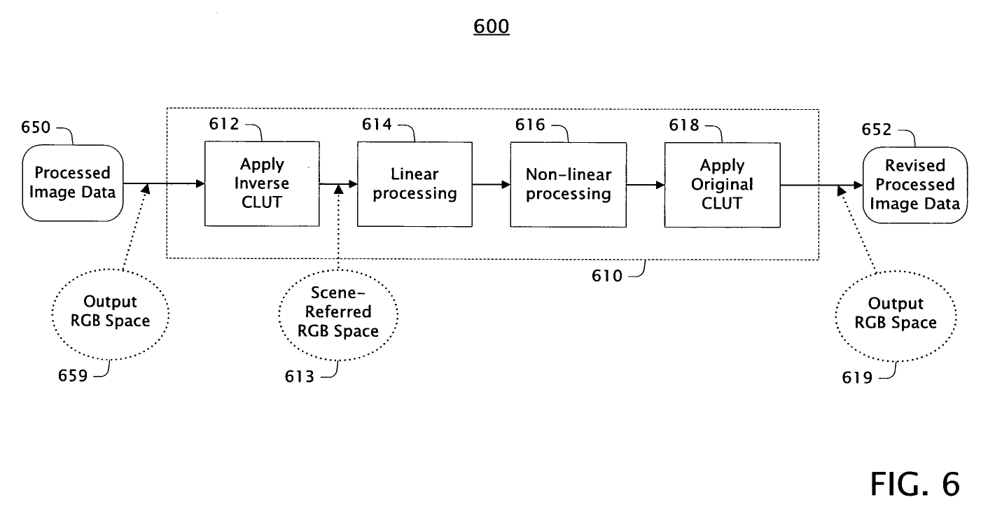

FIG. 6 is a block diagram showing an example method 600 for processing image data such as that produced by method 500 of FIG. 5 and the corresponding CLUT to make further scene-referred adjustments to the image data. Method 600, for example, is useful in making further adjustments to an image that has already had linear and/or nonlinear adjustments made. Method 600 makes use of an associated CLUT to make further scene-referred adjustments to the already-adjusted image data.

Block 650 typically represents processed output-referred image data that is ready to render to an output device and that contains an embedded scene-referred CLUT. Once the processed image data and associated CLUT is available, method 600 typically continues at block 610.

Block 610 typically represents processing stages for making scene-referred adjustments using a CLUT to processed image data 650. Processed image data 650 in an output RGB space or the like (as indicated by bubble 659) is typically provided as input to processing stages 610. Once processed image data 650 is available, method 600 typically continues at block 612.

Block 612 typically indicates applying the CLUT to processed image data 650 in inverse fashion. This may include interpolation for colors not explicitly included in the CLUT. The resulting image data is in a scene-referred RGB space. Such resulting image data supports additional linear and/or nonlinear high-fidelity adjustments. Once the inverse of the CLUT has been applied resulting in scene-referred image data, method 600 typically continues at block 614.

Block 614 typically indicates various stages of linear processing of the scene-referred image data from block 612. Such linear processing may include examples as provided herein above in connection with FIG. 1 and are applied as incremental adjustments, such as modifying the white balance or adding or subtracting exposure to a scene, and the like. Once the linear processing stages are complete, method 600 typically continues at block 616.

Block 616 typically indicates various stages of incremental nonlinear processing of the scene-referred image data as processed in the stages represented by block 614. Such nonlinear processing may include examples as provided herein above in connection with FIG. 1, and the like. Once the nonlinear processing stages are complete, method 600 typically continues at block 618.

Block 618 typically indicates applying the CLUT to the scene-referred image data as processed in the stages represented by block 616. This may include interpolation for colors not explicitly included in the CLUT. The resulting image data is typically once again in output RGB space (as indicated by bubble 619). Once the CLUT has been applied, method 600 typically continues at block 652.

Block 652 typically represents revised processed image data that is ready to render to an output device. At this point, method 600 is typically complete. Revised processed image data 652 typically includes a scene-referred profile including a CLUT or the like. In one example, a revised CLUT is generated and included in the profile.

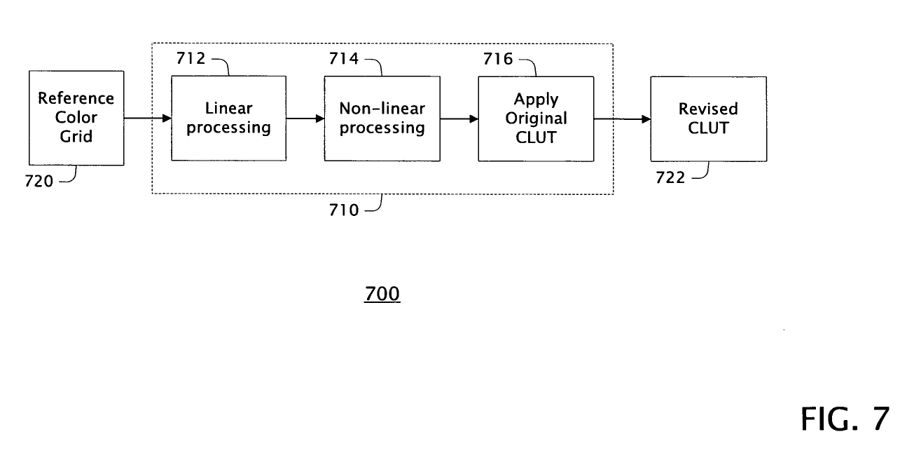

FIG. 7 is a block diagram showing an example method 700 for generating a revised CLUT. Such a revised CLUT is typically included in a profile of correspondingly revised image data, such as described in connection with FIG. 6.

Block 720 typically represents a reference color grid (“RCG”) such as those described in connection with FIGS. 4 and 5. Such an RCG may be included in a profile of corresponding image data such as processed image data 650 described in connection with FIG. 6. Once the RCG is available, method 700 typically continues at block 710.

Block 710 typically represents example processing stages for revising a CLUT. Once an RCG is available, method 700 typically continues at block 712.

Block 712 typically indicates various stages of incremental linear processing of the RCG from block 610. Such linear processing may include examples as provided herein above in connection with FIG. 1, and the like. In one example, the linear processing is the same as that performed in block 614 in connection with FIG. 6. Once the linear processing stages are complete, method 700 typically continues at block 714.

Block 714 typically indicates various stages of incremental nonlinear processing of the RCG as processed in the stages represented by block 712. Such nonlinear processing may include examples as provided herein above in connection with FIG. 1, and the like. In one example, the nonlinear processing is the same as that performed in block 616 in connection with FIG. 6. Once the nonlinear processing stages are complete, method 700 typically continues at block 716.

Block 716 typically indicates applying the original CLUT (as stored in file 650 of FIG. 6) to the RCG as processed in the stages represented by block 714. In one example, the original CLUT is the same CLUT used in block 618 in connection with FIG. 6. The result is typically a revised CLUT. Once the CLUT has been applied, method 600 typically continues at block 722.

Block 722 typically represents a revised CLUT. The revised CLUT is typically included in a profile of corresponding revised image data, such as that described in block 652 in connection with FIG. 6.

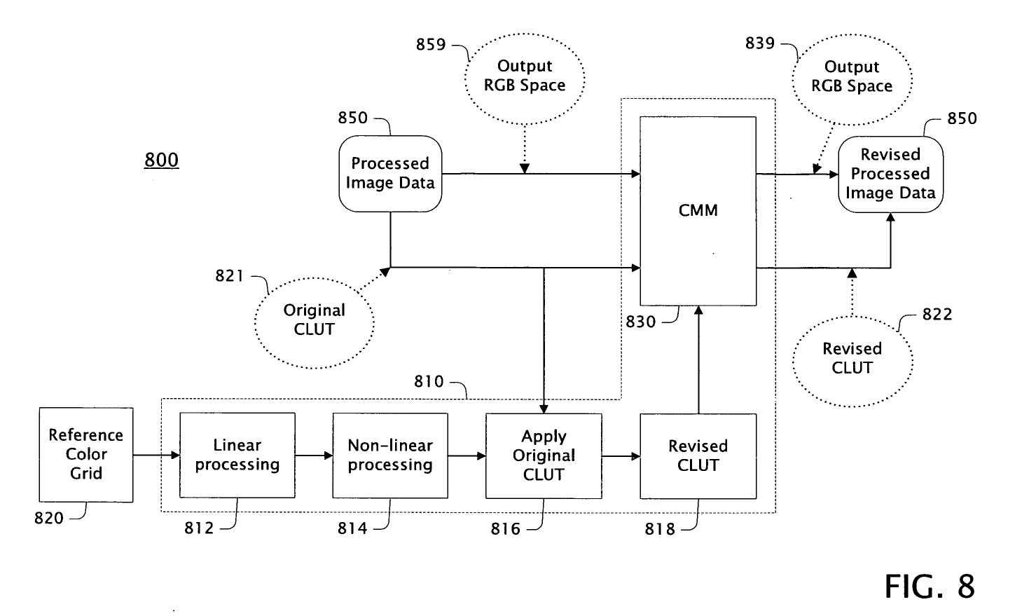

FIG. 8 is a block diagram showing a method 800 for processing image data and a corresponding CLUT to make further scene-referred adjustments to the image data resulting in revised image data and for generating a corresponding revised CLUT. In general, method 800 is an integration of methods 600 and 700 described in connection with FIGS. 6 and 7 respectively. Color look-up table color matching module (CLUT CMM) 830 is a module that generally performs method 600 and includes revised CLUT 818 with revised processed image data 850. Method 800 allows for further scene-referred high-fidelity adjustment of processed image data 850 utilizing a corresponding CLUT 821 including RCG 820. In one example, CLUT 821 and RCG 820 are included in a profile associated with processed image data 850. The result of method 800 is typically revised image data 850 including a corresponding revised CLUT 822. In one example, an RCG is a part of a CLUT—that is, the RCG is the reference half of the CLUT mapping data. In general, an RCG can be derived from a CLUT.

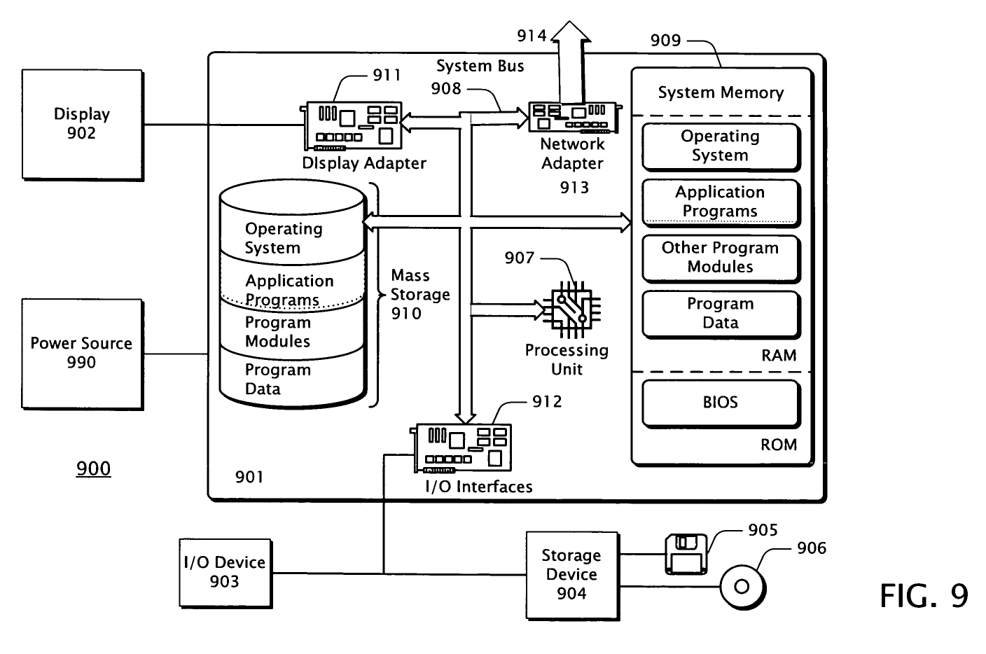

FIG. 9 is a block diagram showing an example computing environment 900 in which the technologies described herein may be implemented. A suitable computing environment may be implemented with numerous general purpose or special purpose systems. Examples of well known systems may include, but are not limited to, cell phones, personal digital assistants (“PDA”), personal computers (“PC”), hand-held or laptop devices, microprocessor-based systems, multiprocessor systems, servers, workstations, consumer electronic devices, set-top boxes, and the like.

Computing environment 900 typically includes a general-purpose computing system in the form of a computing device 901 coupled to various components, such as peripheral devices 902, 903, 904 and the like. System 900 may couple to various other components, such as input devices 903, including voice recognition, touch pads, buttons, keyboards and/or pointing devices, such as a mouse or trackball, via one or more input/output (“I/O”) interfaces 912. The components of computing device 901 may include one or more processors (including central processing units (“CPU”), graphics processing units (“GPU”), microprocessors (“μP”), and the like) 907, system memory 909, and a system bus 908 that typically couples the various components. Processor 907 typically processes or executes various computer-executable instructions to control the operation of computing device 901 and to communicate with other electronic and/or computing devices, systems or environment (not shown) via various communications connections such as a network connection 914 or the like. System bus 908 represents any number of several types of bus structures, including a memory bus or memory controller, a peripheral bus, a serial bus, an accelerated graphics port, a processor or local bus using any of a variety of bus architectures, and the like.

System memory 909 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 909 typically stores data, computer-executable instructions and/or program modules comprising computer-executable instructions that are immediately accessible to and/or presently operated on by one or more of the processors 907.

Mass storage devices 904 and 910 may be coupled to computing device 901 or incorporated into computing device 901 via coupling to the system bus. Such mass storage devices 904 and 910 may include non-volatile RAM, a magnetic disk drive which reads from and/or writes to a removable, non-volatile magnetic disk (e.g., a “floppy disk”) 905, and/or an optical disk drive that reads from and/or writes to a non-volatile optical disk such as a CD ROM, DVD ROM 906. Alternatively, a mass storage device, such as hard disk 910, may include non-removable storage medium. Other mass storage devices may include memory cards, memory sticks, tape storage devices, and the like.

Any number of computer programs, files, data structures, and the like may be stored in mass storage 910, other storage devices 904, 905, 906 and system memory 909 (typically limited by available space) including, by way of example and not limitation, operating systems, application programs, data files, directory structures, computer-executable instructions, and the like.

Output components or devices, such as display device 902, may be coupled to computing device 901, typically via an interface such as a display adapter 911. Output device 902 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 901 to interact with human operators or other machines, systems, computing environments, or the like. A user may interface with computing environment 900 via any number of different I/O devices 903 such as a touch pad, buttons, keyboard, mouse, joystick, game pad, data port, and the like. These and other I/O devices may be coupled to processor 907 via I/O interfaces 912 which may be coupled to system bus 908, and/or may be coupled by other interfaces and bus structures, such as a parallel port, game port, universal serial bus (“USB”), fire wire, infrared (“IR”) port, and the like.

Computing device 901 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 901 may be coupled to a network via network adapter 913 or the like, or, alternatively, via a modem, digital subscriber line (“DSL”) link, integrated services digital network (“ISDN”) link, Internet link, wireless link, or the like.

Communications connection 914, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 990, such as a battery or a power supply, typically provides power for portions or all of computing environment 900. In the case of the computing environment 900 being a mobile device or portable device or the like, power source 990 may be a battery. Alternatively, in the case computing environment 900 is a desktop computer or server or the like, power source 990 may be a power supply designed to connect to an alternating current (“AC”) source, such as via a wall outlet.

Some mobile devices may not include many of the components described in connection with FIG. 9. For example, an electronic badge may be comprised of a coil of wire along with a simple processing unit 907 or the like, the coil configured to act as power source 990 when in proximity to a card reader device or the like. Such a coil may also be configure to act as an antenna coupled to the processing unit 907 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 902, I/O device 903, or many of the other components described in connection with FIG. 9. Other mobile devices that may not include many of the components described in connection with FIG. 9, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A method of performing scene-referred high-fidelity adjustments to processed image data, the method comprising:
reading a color look-up table from a profile of the processed image data;
deriving a reference color grid from the color look-up table;
applying the color look-up table in inverse fashion to the processed image data resulting in scene-referred image data;
performing one or more stages of linear processing and/or nonlinear processing on the scene-referred image data resulting in processed image data;
performing the one or more stages of linear processing and/or nonlinear processing on the reference color grid resulting in a processed reference color grid;
applying the color look-up table to the processed image data and the processed reference color grid resulting in revised processed image data and a revised color look-up table; and
including the revised color look-up table with the revised processed image data.

2. The method of claim 1 wherein the profile is encoded as an International Color Consortium profile.

3. The method of claim 1 wherein the reference color grid is a collection of values representing various colors.

4. The method of claim 1 wherein the revised processed image data is processed by a color matching module for rendering on an output device.

5. A method of processing rare image data comprising:
generating a reference color grid;
performing one or more stages of linear processing on the rare image data resulting in processed image data;
performing one or more stages of further linear processing and/or nonlinear processing on the reference color grid resulting in a color look-up table; and
applying the color look-up table to the processed image data.

6. The method of claim 5 wherein the rare image data is raw sensor data;

7. The method of claim 5 wherein the reference color grid is a collection of values representing various colors.

8. The method of claim 5 wherein the processed image data is processed by a color matching module for rendering on an output device.

9. A method of processing raw image data comprising:
generating a reference color grid based on the raw image data; and
performing one or more stages of linear processing and/or nonlinear processing on the reference color grid resulting in a color look-up table.

10. The method of claim 9 wherein the reference color grid is a collection of values representing various colors.

11. The method of claim 9 further comprising:
performing one or more stages of other linear processing on the raw image data resulting in rare image data; and
applying the color-lookup table to the rare image data resulting in processed image data.

12. The method of claim 11 wherein the processed image data is processed by a color matching module for rendering on an output device.

13. The method of claim 11 further comprising including the color look-up table in a profile associated with the processed image data, the color look-up table including the reference color grid.

14. The method of claim 13 further comprising reading the color look-up table from the profile of the processed image data.

15. The method of claim 14 further comprising applying the color look-up table in inverse fashion to the processed image data resulting in scene-referred image data.

16. The method of claim 15 further comprising performing one or more additional stages of linear processing and/or nonlinear processing on the scene-referred image data resulting in further processed image data.

17. The method of claim 16 further comprising performing the one or more additional stages of linear processing and/or nonlinear processing on the reference color grid resulting in a revised reference color grid.

18. The method of claim 17 further comprising applying the color look-up table to the further processed image data and the revised reference color grid resulting in revised processed image data and a revised color look-up table.

19. The method of claim 18 further comprising including the revised color look-up table in a revised profile associated with the revised processed image data.

20. The method of claim 19 wherein the revised processed image data is processed by a color matching module for rendering on an output device.
